(19) United States
(12) Patent Application Publication
(10) Pub. No.: US 2022/0236175 A1
(43) Pub. Date: Jul. 28, 2022

(54) NONDISPERSIVE INFRARED-TYPE CARBON DIOXIDE GAS SENSOR

(71) Applicant: TAESUNG ENVIRONMENTAL RESEARCH INSTITUTE CO., LTD., Jisan (KR)

(72) Inventors: Kwang Bum PARK, Seongnam-si, Gyeonggi-do (KR); Dae Sung LEE, Yongin-si, Gyeonggi-do (KR); Chai Rok LIM, Ulsan (KR); Chun Kon SONG, Ulsan (KR); Gi Yeol YUN, Ulsan (KR); Seok Man KIM, Ulsan (KR)

(21) Appl. No.: 17/617,475

(22) PCT Filed: Dec. 7, 2020
(86) PCT No.: PCT/KR2020/017792

§ 371 Date: Dec. 8, 2021

(30) Foreign Application Priority Data
Dec. 11, 2019 (KR) 10-2019-0164506

(51) Int. Cl. G01N 21/3504

(52) U.S. Cl. CPC G01N 21/3504; G01N 2201/08

(57) ABSTRACT

A non-dispersive infrared-type carbon dioxide gas sensor includes: an optical retaining device having an optical waveguide formed along a circular outer periphery; an infrared light source unit installed on one end of the optical waveguide; and an infrared sensor unit installed at the center space of the optical retaining device and connected to the other end of the optical waveguide. The infrared sensor unit includes a first infrared sensor having a filter such that infrared rays in wavelength bands to be measured selectively pass through same, and a second infrared sensor having a filter such that infrared rays in wavelength bands, which are not absorbed, can selectively pass through same.

### TECHNICAL FIELD

The present invention relates to a non-dispersive infrared-type carbon dioxide gas sensor, and more particularly, to an infrared optical gas sensor for selectively detecting a gas absorbing infrared light using non-dispersive infrared light in a specific infrared wavelength band.

### BACKGROUND ART

Gas sensors according to the related art use a contact-type method that measures changes in physical properties that occur when gas molecules are adsorbed to a detection material and converts the measured changes into concentrations, and examples of the gas sensors include a semiconductor-type gas sensor using a metal chemical and an electrochemical gas sensor using an electrolyte. In the case of the contact-type gas sensor, many types of gases may be measured, a response speed thereof may be high, and a weight thereof may be reduced.

However, measurement accuracy and gas selectivity are degraded, and moreover, since detection materials such as a medal oxide or an electrolyte react with a gas while being in direct contact with the gas, a lifetime thereof is short due to degradation of the detection materials. Further, moisture present in the atmosphere reacts with most of the detection materials to interfere with detection of to-be-detected gases, and thus in order to stably detect the gas, a separate system that may pre-treat the moisture is required.

In order to solve the above problems, in recent years, an optical method is spotlighted which has high measurement accuracy and high gas selectivity by measuring the light absorption of gas molecules using a gas sensor method and converting the measured light absorption into a concentration. In particular, a non-dispersive infrared (NDIR) gas sensor has been developed which calculates the concentration of the carbon dioxide by measuring how much of an amount of light passing through a test gas is absorbed by carbon dioxide molecules, and thus the existing gas sensor is gradually replaced.

However, in the NDIR gas sensor, the component cost is relatively high, and thus productivity is low, and a monoatomic molecule gas cannot be measured. In particular, in order to measure a weak signal of an infrared sensor, the NDIR gas sensor includes a single power differential amplifier circuit having a high amplification ratio. In this case, a region in which a gas concentration cannot be measured is generated due to a large deviation between initial output values of a measurement infrared detector and a reference infrared detector.

Korean Patent No. 10-1753873 (Title: Infrared light scattering compensation non-distributed type smoke sensing device) that is the related art discloses a technology that may facilitate flow of air and measure fire smoke without a mold coated with expensive reflective materials while minimizing the effect of unwanted fire alarm inducing substances such as water vapor and dust.

However, even according to the related art described above, the inability of measuring the gas concentration due to an initial deviation between detection values of the existing dual infrared sensor is not resolved, and thus the suggestion of a technical solution of removing a gas-unmeasurable region by minimizing the deviation stills remains as a technical solution.

### DISCLOSURE

### Technical Problem

The present invention is directed to providing a carbon dioxide gas sensor capable of more stably driving gas measurement by adjusting the intensity of infrared light incident on a dual infrared sensor through rotation of an infrared inclined mirror constituting a non-dispersive infrared (NDIR) carbon dioxide gas sensor.

### Technical Solution

One aspect of the present invention provides a non-dispersive infrared (NDIR) carbon dioxide gas sensor including an optical fixing mechanism provided with an optical waveguide formed along a circular perimeter, an infrared light source unit installed at one end of the optical waveguide, an infrared sensor unit provided in a central space of the optical fixing mechanism and connected to the other end of the optical waveguide, an inclined mirror unit installed at an upper end of the infrared sensor unit and having a lower mirror that allows infrared light reaching the other end of the optical waveguide to be incident on the infrared sensor unit, and a mechanism cover part surrounding an upper part of the optical fixing mechanism and having a plurality of gas holes so that a gas flows into or discharged from the optical waveguide, wherein the infrared sensor unit includes a first infrared sensor having a filter that allows infrared light having a wavelength band that is measured to selectively pass therethrough and a second infrared sensor having a filter that allows infrared light having a wavelength band that is not absorbed to selectively pass therethrough.

The inclined mirror unit may be installed to rotate about a center of the infrared sensor unit in a clockwise direction or a counterclockwise direction and adjust an incident area of the infrared light onto the first infrared sensor and the second infrared sensor.

The optical fixing mechanism may further include a light-reflective surface that is installed at the other end of the optical waveguide and refracts a traveling path of the infrared light to the central space.

The mechanism cover part may have the plurality of gas holes that are spaced apart from each other at regular intervals along an upper part of the optical waveguide that is circular.

An inner surface of the optical waveguide or the lower mirror may be coated with gold (Au).

In the infrared sensor unit, the first infrared sensor and the second infrared sensor may form a single power differential amplifier circuit to indicate an output voltage (V₀).

The NDIR carbon dioxide gas sensor may further include a control calculation unit that controls clockwise or counterclockwise rotation of the inclined mirror unit, wherein the control calculation unit receives data of a voltage (V₁) detected by the first infrared sensor and a voltage (V₂) detected by the second infrared sensor, calculates an amount of a change in the voltage (V₁) detected by the first infrared sensor, which is required for the output voltage (V₀) by the single power differential amplifier circuit to have a positive (+) value, and transmits a control signal for a rotation direction or range to the inclined mirror unit.

### Advantageous Effects

According to one aspect of the present invention, a difference between initial output values of a measurement infrared detector and a reference infrared detector of a dual infrared sensor used in a non-dispersive infrared (NDIR) sensor can be corrected by a simple rotation operation of an inclined mirror, and thus a gas-unmeasurable state can be solved, and a gas can be measured more stably.

The effects of the present invention are not limited to the above effects and should be understood to include all effects that may be deduced from the detailed description of the present invention or the configuration of the present invention described in the appended claims.

### DESCRIPTION OF DRAWINGS

FIGS. 1A to 1D are top views illustrating a non-dispersive infrared (NDIR) carbon dioxide gas sensor according to an assembly sequence according to an embodiment of the present invention.

FIG. 2 is a projected side view of the NDIR carbon dioxide gas sensor of FIG. 1.

FIGS. 3A to 3C are top views illustrating, in shaded areas, changes in incident areas of an infrared sensor unit according to the counterclockwise rotation of an inclined mirror unit according to the embodiment of the present invention.

FIG. 4 is a circuit diagram illustrating a single power differential amplifier circuit formed by a dual infrared sensor of the infrared sensor unit according to the embodiment of the present invention.

### MODES OF THE INVENTION

Hereinafter, the present invention will be described with reference to the accompanying drawings. However, the present invention may be implemented in various different forms and thus is not limited to embodiments described herein. Further, in the drawings, parts irrelevant to the description are omitted in order to clearly describe the present invention, and throughout the specification, the similar numerals reference numerals are assigned to the similar parts.

Throughout the specification, when a first part is connected to a second part, this includes not only a case in which the first part is “directly connected” to the second part but also a case in which the first part is “indirectly connected” to the second part with a third part interposed therebetween. Further, when a part “includes” a component, this means that another component is not excluded but may be further included unless otherwise stated.

Hereinafter, embodiments of the present invention will be described in detail with reference to the accompanying drawings.

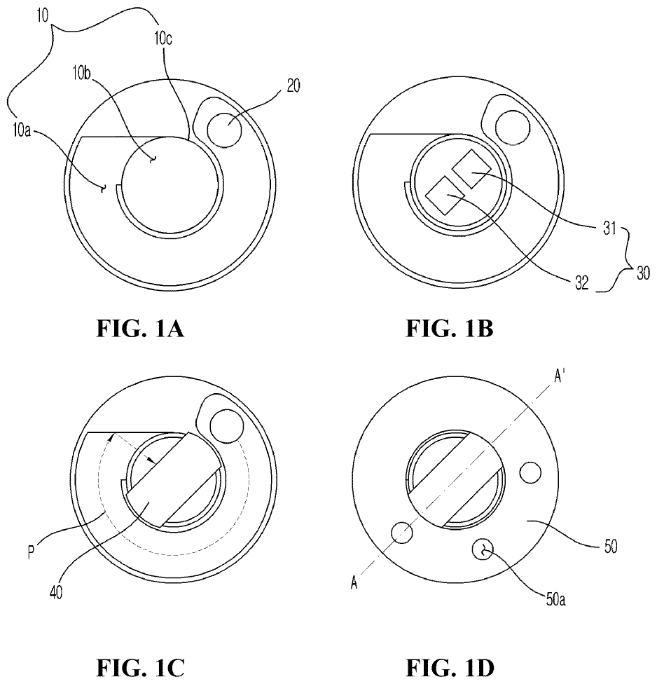

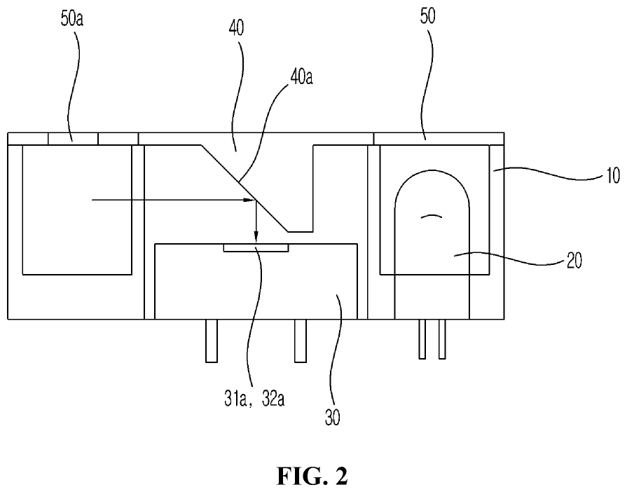

FIGS. 1A to 1D are top views illustrating a non-dispersive infrared (NDIR) carbon dioxide gas sensor according to an assembly sequence according to an embodiment of the present invention, and FIG. 2 is a projected side view of the NDIR carbon dioxide gas sensor of FIG. 1.

As illustrated, the NDIR carbon dioxide gas sensor includes, as components constituting a basic structure of the present invention, an optical fixing mechanism 10, an infrared light source unit 20, an infrared sensor unit 30, an inclined mirror unit 40, and a mechanism cover part 50.

A gas detection method of the carbon dioxide gas sensor according to the present invention is an NDIR method. This is a method of calculating the concentration of carbon dioxide by measuring how much of an amount of light is absorbed by carbon dioxide molecules. Since the NDIR method is obvious to those skilled in the art to which the present invention pertains, a detailed description thereof will be omitted.

FIG. 1A illustrates a state in which the infrared light source unit 20 is installed in the optical fixing mechanism 10.

The optical fixing mechanism 10, which is a component constituting a body frame of the carbon dioxide gas sensor according to the present invention, may be formed in a circular shape as illustrated. A central space 10b into which the infrared sensor unit 30 may be inserted is provided in a center of the optical fixing mechanism 10, and a groove constituting an optical waveguide 10a that is a path through which infrared light travels may be formed along an outer edge thereof.

One end of the optical waveguide 10a is formed to be connected to the central space 10b installed in the infrared sensor unit 30. As illustrated, the optical waveguide 10a may have a concentric circle with the central space 10b and may be formed in a structure surrounding the central space 10b.

The infrared light source unit 20 is a configuration configured to emit infrared light necessary for measuring a gas and is installed at one end of the optical waveguide 10a opposite to the central space 10b in which the infrared sensor unit 30 is installed. The infrared light emitted from the infrared light source unit 20 travels along the optical waveguide 10a while being reflected a plurality of times and is incident on the infrared sensor unit 30.

The optical waveguide 10a according to the embodiment of the present invention may be coated with gold (Au) in order to increase the reflection efficiency of the infrared light which travels thereinside while being reflected a plurality of times.

The optical fixing mechanism 10 according to the embodiment of the present invention may further include a light-reflective surface 10c that is installed at the other end of the optical waveguide 10a and refracts a traveling path of the infrared light to the central space 10b.

FIG. 1B illustrates a state in which the infrared light source unit 20 and the infrared sensor unit 30 are installed in the optical fixing mechanism 10.

The infrared sensor unit 30 is installed in the central space 10b formed in the center of the optical fixing mechanism 10. The infrared sensor unit 30 is a configuration configured to receive the infrared light traveling along the optical waveguide 10a to detect the concentration of the carbon dioxide.

The infrared sensor unit 30 according to the embodiment of the present invention is configured as a dual infrared sensor including a first infrared sensor 31 and a second infrared sensor 32 having different purposes. In more detail, the first infrared sensor 31 having a filter that may allow the infrared light in a wavelength band to be measured to selectively pass therethrough and the second infrared sensor 32 having a filter that may allow the infrared light in a wavelength band not to be absorbed to selectively pass therethrough may be arranged side by side.

The first infrared sensor 31 serves as a measurement infrared detector, and a first window 31a including a narrow band filter, through which the infrared light belonging to a measurement wavelength band and absorbed by the gas may selectively pass, is installed on an upper surface thereof.

The second infrared sensor 32 serves as a reference infrared detector, and a second window 32a including a narrow band filter through which the infrared light belonging to a specific reference wavelength band and not absorbed by the gas may selectively pass is installed on an upper surface thereof.

Outputs of the first infrared sensor 31 and the second infrared sensor 32 constituting the dual infrared sensor may be different in their initial detections. In order to compensate for this difference, there may be inconveniences such as having to modify a circuit every time, but this difference may be easily corrected by a rotation structure of the inclined mirror unit 40 according to the embodiment, which will be described below.

FIG. 1C illustrates a traveling direction P of the infrared light according to the optical waveguide 10a in a state in which the inclined mirror unit 40 is installed above the infrared sensor unit 30 according to the present invention.

The inclined mirror unit 40 is installed to surround a part of an upper end of the infrared sensor unit 30 and is provided with a lower mirror 40a for refracting the infrared light traveling along the optical waveguide 10a. In more detail, the inclined mirror unit 40 has a predetermined area overlapping the windows 31a and 32a formed on the upper surface of the infrared sensor unit 30, and the lower mirror 40a refracts the infrared light so that the infrared light is incident on the infrared sensor unit 30.

The lower mirror 40a according to the embodiment of the present invention may be coated with gold (Au) in order to increase the reflection efficiency of the infrared light refracted in a direction of the infrared sensor unit 30. In addition, a flat surface, a concave curved surface, or a parabolic shape may be applied to the lower mirror 40a.

As illustrated, the inclined mirror unit 40 may be located to surround both the first window 31a and the second window 32a of the infrared sensor unit 30, may be formed to rotate in a clockwise direction or counterclockwise direction therefrom, and may adjust an incident area of the infrared light. A detailed description thereof will be described below.

FIG. 1D illustrates a state in which the mechanism cover part 50 is cover-coupled to the optical fixing mechanism 10 according to the present invention.

The mechanism cover part 50 is installed at an upper end of the optical fixing mechanism 10 and is cover-coupled to the optical fixing mechanism 10. Accordingly, a lower surface of the mechanism cover part 50 along an outer edge thereof forms the optical waveguide 10a together with an outer edge of the optical fixing mechanism 10.

The mechanism cover part 50 according to the present invention has a plurality of gas holes 50a through which the gas to be detected may be introduced or discharged. That is, the gas to be detected may smoothly flow into and discharged from the optical waveguide 10a through the plurality of gas holes 50a.

In this case, the plurality of gas holes 50a according to the embodiment of the present invention may be formed to be spaced apart from each other at regular intervals along the circular optical waveguide 10a. This is for maintaining the concentration of the gas to be detected that flows into or discharged from a traveling path of the optical waveguide 10a constant.

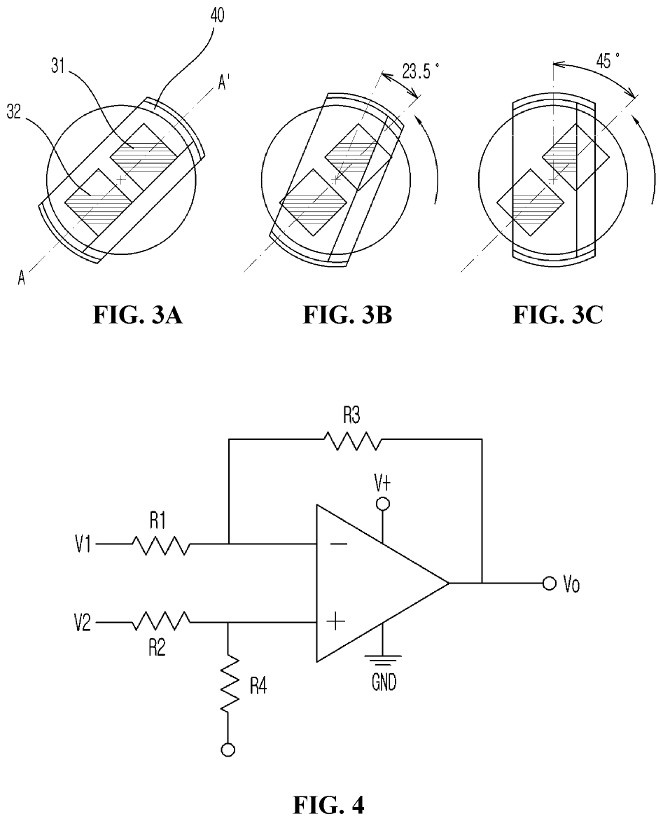

Hereinafter, technical features for correcting a difference between initial outputs of the dual infrared sensor according to the embodiment of the present invention will be described in detail with reference to FIGS. 3 and 4.

FIGS. 3A to 3C are top views illustrating, in shaded areas, changes in incident areas of the infrared sensor unit 30 according to the counterclockwise rotation of the inclined mirror unit 40 according to the embodiment of the present invention.

The inclined mirror unit 40 according to the embodiment of the present invention is installed to be rotatable about the center of the infrared sensor unit 30 in the clockwise direction or counterclockwise direction and thus adjusts the incident areas of the infrared light to the first infrared sensor 31 and the second infrared sensor 32.

As the incident area becomes wider, the output of a detector of each of the first infrared sensor 31 and the second infrared sensor 32 increases.

Further, the carbon dioxide gas sensor according to the embodiment of the present invention may further include a control calculation unit 60 (not illustrated) that receives detection data from the infrared sensor unit 30 and calculates a rotation value of the inclined mirror unit 40 in the clockwise direction or the counterclockwise direction of the inclined mirror unit 40.

FIG. 3A illustrates a state in which the inclined mirror unit 40 overlaps all of the windows 31a and 32a of the infrared sensor unit 30 according to the embodiment of the present invention. This is a location corresponding to line A-A′ illustrated in FIG. 1D.

In this state, the first infrared sensor 31 and the second infrared sensor 32 have the same incident area from a reflective surface.

Thereafter, FIGS. 3B and 3C illustrate states in which the inclined mirror unit 40 overlaps parts of the windows 31a and 32a of the infrared sensor unit 30 while being rotated by 22.5 degrees and 45 degrees in the counterclockwise direction, respectively.

As illustrated through FIG. 3, it may be seen that, as the inclined mirror unit 40 is rotated in the counterclockwise direction, the incident areas for the windows of the first infrared sensor 31 and the second infrared sensor 32 are greatly reduced. That is, through the above-described structure in which the inclined mirror unit 40 rotates in the clockwise direction or counterclockwise direction, an initial deviation between output values of the first infrared sensor 31 and the second infrared sensor 32 may be corrected.

FIG. 4 is a circuit diagram illustrating a single power differential amplifier circuit formed by a dual infrared sensor of the infrared sensor unit 30 according to the embodiment of the present invention in order to measure a weak signal of the dual infrared sensor.

The infrared sensor unit 30 according to the embodiment of the present invention may be a differential amplifier circuit in which the first infrared sensor 31 and the second infrared sensor 32 receive two input signals configured as a single power supply and output a difference between the two input signals. This is for outputting the difference between the signals at a high amplification ratio so that the weak signal of the infrared sensor may be measured.

When the relationship between resistors illustrated in FIG. 4 is set as R1=R2 and R3=R4, an amplification ratio Gain of the corresponding differential amplifier circuit is a ratio of R3 to R1, i.e.,

$$Gain = \frac{R 3}{R 1} .$$

In this case, an output voltage V₀ of the single power differential amplifier circuit is calculated in Equation 1 as follows.

$${V}_{0} = ( {V}_{2} - {V}_{1} ) \cdot Gain - {V}_{com} \qquad Equation ( 1 )$$

In Equation (1), V₁ denotes a voltage value detected by the first infrared sensor 31, V₂ denotes a voltage value detected by the second infrared sensor 32, and Vcom denotes a predetermined voltage value preset and input to the control calculation unit. Information on each of the detected or input voltage values is provided as calculation data of the control calculation unit.

When the concentration of the gas in the optical waveguide 10a increases, the amount of infrared light absorbed by the gas increases, and accordingly, the voltage value V₁ detected by the first infrared sensor 31 decreases. Unlike this, the voltage value V₂ detected by the second infrared sensor 32 is maintained at a constant value without change.

In this case, when the voltage value V₁ detected by the first infrared sensor 31 is greater than the voltage value V₂ detected by the second infrared sensor 32 by a predetermined value or more, the value of a right-hand term of Equation (1) becomes a negative (−) value. As a result, a value of 0 V is output as the output voltage V₀ of the single power differential amplifier circuit.

Thus, until the concentration of the gas is sufficiently high, the voltage value V₁ detected by the first infrared sensor 31 is reduced, and thus a positive (+) value is output as a value of the right-hand side of Equation (1), a gas-unmeasurable region occurs in which the NDIR carbon dioxide gas sensor according to the present invention cannot measure the gas.

In order to solve the above problem, in an initial state in which there is no gas, in the NDIR carbon dioxide gas sensor according to the present invention, as illustrated in FIG. 3, the inclined mirror unit 40 may be rotated in the clockwise direction or counterclockwise direction to adjust the incident area of the infrared light, thereby adjusting the intensity of the infrared light incident on the infrared sensor unit 30.

That is, the inclined mirror unit 40 adjusts the intensities of the infrared light incident on the first infrared sensor 31 and the second infrared sensor 32 so that the right-hand term of Equation (1) outputs a positive (+) value in the initial state. As a result, the difference between the output values in the initial detection may be easily corrected by a simple rotating operation for the inclined mirror unit 40 without separate circuit correction or a pre-treatment system. Accordingly, the problem of not being able to measure an initial gas concentration can be solved, and at the same time, productivity can be increased due to a gas sensor for mass production.

The control calculation unit 60 according to the embodiment of the present invention may receive the voltage V₁ detected by the first infrared sensor 31 and the voltage value V₂ detected by the second infrared sensor 32, and calculates, on the basis of the received voltages, the amount of a change in the voltage V₁ detected by the first infrared sensor 31, which is required for the output voltage V₀ by the single power differential amplifier circuit according to Equation (1) to have a positive (+) value.

Thereafter, the control calculation unit 60 may be formed as a module that transmits a control signal for a rotation direction or a rotation range required for the inclined mirror unit 40 in order to satisfy the calculated amount of the change in the voltage V₁ detected by the first infrared sensor 31.

According to the above-described various embodiments, the carbon dioxide gas sensor according to the present invention may eliminate the gas-unmeasurable region caused by a difference between initial output values of the measurement infrared detector and the reference infrared detector of the dual infrared sensor used in the NDIR sensor.

Further, there is no trouble of needing to modify a circuit every time to compensate for the above-described difference between the initial output values when the NDIR sensor is mass-produced, a separate pre-treatment system is not required, and thus productivity can be increased.

The above description of the present invention is merely illustrative, and those skilled in the art to which the present invention pertains can understand that the present invention can be easily modified in other specific forms without changing the technical spirit or essential features of the present invention. Therefore, it should be understood that the embodiments described above are illustrative but not limiting in all aspects. For example, components described as a single type may be implemented in a dispersed form, and likewise, components described as a dispersed form may also be implemented in a coupled form.

The scope of the present invention is indicated by the appended claims, and all changes or modifications derived from the meaning and scope of the appended claims and equivalent concepts thereof should be construed as being included in the scope of the present invention.

What is claimed is:

1. A non-dispersive infrared (NDIR) carbon dioxide gas sensor comprising:
an optical fixing mechanism provided with an optical waveguide formed along a circular perimeter;
an infrared light source unit installed at one end of the optical waveguide;
an infrared sensor unit provided in a central space of the optical fixing mechanism and connected to the other end of the optical waveguide;
an inclined mirror unit installed at an upper end of the infrared sensor unit and having a lower mirror that allows infrared light reaching the other end of the optical waveguide to be incident on the infrared sensor unit; and
a mechanism cover part surrounding an upper part of the optical fixing mechanism and having a plurality of gas holes so that a gas flows into or discharged from the optical waveguide,
wherein the infrared sensor unit includes a first infrared sensor having a filter that allows infrared light having a wavelength band that is measured to selectively pass therethrough and a second infrared sensor having a filter that allows infrared light having a wavelength band that is not absorbed to selectively pass therethrough.

2. The NDIR carbon dioxide gas sensor of claim 1, wherein the inclined mirror unit is installed to rotate about a center of the infrared sensor unit in a clockwise direction or a counterclockwise direction and adjusts an incident area of the infrared light onto the first infrared sensor and the second infrared sensor.

3. The NDIR carbon dioxide gas sensor of claim 2, wherein the optical fixing mechanism further includes a light-reflective surface that is installed at the other end of the optical waveguide and refracts a traveling path of the infrared light to the central space.

4. The NDIR carbon dioxide gas sensor of claim 2, wherein the mechanism cover part has the plurality of gas holes that are spaced apart from each other at regular intervals along an upper part of the optical waveguide that is circular.

5. The NDIR carbon dioxide gas sensor of claim 2, wherein an inner surface of the optical waveguide or the lower mirror is coated with gold (Au).

6. The NDIR carbon dioxide gas sensor of claim 2, wherein, in the infrared sensor unit, the first infrared sensor and the second infrared sensor form a single power differential amplifier circuit to indicate an output voltage (V₀).

7. The NDIR carbon dioxide gas sensor of claim 6, further comprising a control calculation unit that controls clockwise or counterclockwise rotation of the inclined mirror unit,
wherein the control calculation unit receives data of a voltage (V₁) detected by the first infrared sensor and a voltage (V₂) detected by the second infrared sensor, calculates an amount of a change in the voltage (V₁) detected by the first infrared sensor, which is required for the output voltage (V₀) by the single power differential amplifier circuit to have a positive (+) value,
and transmits a control signal for a rotation direction or range to the inclined mirror unit.
